(19) United States
(12) Patent Application Publication
(10) Pub. No.: US 2026/0340933 A1
(43) Pub. Date: Oct. 29, 2026

(54) SYSTEMS AND METHODS FOR RECONSTRUCTING AND RENDERING ARTICULATED OBJECTS USING 3D GAUSSIAN SPLATTING

(71) Applicant: Toyota Research Institute, Inc., Los Altos, CA (US)

(72) Inventors: Shengjie Lin, Redwood City, CA (US); Jiading Fang, Chicago, IL (US); Muhammad Zubair Irshad, Milpitas, CA (US); Vitor Campagnolo Guizilini, Santa Clara, CA (US); Rares Andrei Ambrus, San Francisco, CA (US); Gregory Shakhnarovich, Chicago, IL (US); Matthew R. Walter, Chicago, IL (US)

(73) Assignees: Toyota Research Institute, In, Los Altos, CA (US); Toyota Jidosha Kabushiki Kaisha, Toyota-shi (JP); Toyota Technological Institute at Chicago, Chicago, IL (US)

(21) Appl. No.: 19/187,006

(22) Filed: Apr. 23, 2025

(51) Int. Cl. G06T 15/20; G05B 19/4099; G06T 17/00; G06T 19/00

(52) U.S. Cl. CPC G06T 15/205; G05B 19/4099; G06T 17/00; G06T 19/00; G05B 2219/35134

(57) ABSTRACT

Systems and methods for reconstructing and rendering articulated objects using three-dimensional (3D) Gaussian Splatting are disclosed. One embodiment is a system that pre-processes two sets of posed images of an articulated object corresponding to two different articulation states of the articulated object. The system also generates, through a three-stage self-supervised optimization process based on the two sets of posed images, a 3D reconstruction model employing 3D Gaussian Splatting that synthesizes novel views and articulation states of the articulated object. The 3D reconstruction model reconstructs the articulated object in the two original articulation states in the first stage, identifies a static part and a movable part of the articulated object in the second stage, and models movement of the moveable part relative to the static part in the third stage. The system also outputs the 3D reconstruction model to a computing platform that applies the 3D reconstruction model.

### TECHNICAL FIELD

The subject matter described herein relates in general to three-dimensional (3D) reconstruction and, more specifically, to systems and methods for reconstructing and rendering articulated objects using 3D Gaussian Splatting.

### BACKGROUND

Articulated objects such as doors, drawers, and scissors are ubiquitous in everyday life. Estimating their motion and reconstructing their structure is important to a variety of applications in robotics, computer vision, and augmented reality. Conventional solutions involve extensive human engineering, heavy three-dimensional (3D) supervision, part segmentation, 3D annotations, and/or articulation annotations. Such solutions thus involve significant labor and lack practicality.

### SUMMARY

An example of a system for reconstructing and rendering articulated objects using three-dimensional (3D) Gaussian Splatting is presented herein. The system comprises a processor and a memory storing machine-readable instructions that, when executed by the processor, cause the processor to pre-process first and second sets of posed images of an articulated object that correspond, respectively, to first and second articulation states of the articulated object. The memory also stores machine-readable instructions that, when executed by the processor, cause the processor to generate, through first, second, and third stages of a self-supervised optimization process based on the first and second sets of posed images, a 3D reconstruction model employing 3D Gaussian Splatting that synthesizes novel views and articulation states of the articulated object. The 3D reconstruction model reconstructs the articulated object in the first and second articulation states, respectively, in the first stage, identifies a static part and a movable part of the articulated object in the second stage, and models movement of the moveable part relative to the static part in the third stage. The memory also stores machine-readable instructions that, when executed by the processor, cause the processor to output the 3D reconstruction model to a computing platform that performs one or more of visualization, simulation, interactive simulation, analysis, design, troubleshooting, and fabrication pertaining to the articulated object.

Another embodiment is a non-transitory computer-readable medium for reconstructing and rendering articulated objects using 3D Gaussian Splatting and storing instructions that, when executed by a processor, cause the processor to pre-process first and second sets of posed images of an articulated object that correspond, respectively, to first and second articulation states of the articulated object. The instructions also cause the processor to generate, through first, second, and third stages of a self-supervised optimization process based on the first and second sets of posed images, a 3D reconstruction model employing 3D Gaussian Splatting that synthesizes novel views and articulation states of the articulated object. The 3D reconstruction model reconstructs the articulated object in the first and second articulation states, respectively, in the first stage, identifies a static part and a movable part of the articulated object in the second stage, and models movement of the moveable part relative to the static part in the third stage. The instructions also cause the processor to output the 3D reconstruction model to a computing platform that performs one or more of visualization, simulation, interactive simulation, analysis, design, troubleshooting, and fabrication pertaining to the articulated object.

Another embodiment is a method of reconstructing and rendering articulated objects using 3D Gaussian Splatting, the method comprising pre-processing first and second sets of posed images of an articulated object that correspond, respectively, to first and second articulation states of the articulated object. The method also includes generating, through first, second, and third stages of a self-supervised optimization process based on the first and second sets of posed images, a three-dimensional (3D) reconstruction model employing 3D Gaussian Splatting that synthesizes novel views and articulation states of the articulated object. The 3D reconstruction model reconstructs the articulated object in the first and second articulation states, respectively, in the first stage, identifies a static part and a movable part of the articulated object in the second stage, and models movement of the moveable part relative to the static part in the third stage. The method also includes outputting the 3D reconstruction model to a computing platform that performs one or more of visualization, simulation, interactive simulation, analysis, design, troubleshooting, and fabrication pertaining to the articulated object.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1A is a diagram of the first stage of a three-stage self-supervised optimization process to generate a three-dimensional (3D) reconstruction model that synthesizes novel views and articulation states of an articulated object using 3D Gaussian Splatting, in accordance with an illustrative embodiment of the invention.

FIG. 1B is a diagram of the second stage of a three-stage self-supervised optimization process to generate a 3D reconstruction model that synthesizes novel views and articulation states of an articulated object using 3D Gaussian Splatting, in accordance with an illustrative embodiment of the invention.

FIG. 1C is a diagram of the third stage of a three-stage self-supervised optimization process to generate a 3D reconstruction model that synthesizes novel views and articulation states of an articulated object using 3D Gaussian Splatting, in accordance with an illustrative embodiment of the invention.

FIG. 2 is a block diagram of an articulated-objects 3D reconstruction and rendering system, in accordance with an illustrative embodiment of the invention.

FIG. 3 is a flowchart of a method of reconstructing and rendering articulated objects using 3D Gaussian Splatting, in accordance with an illustrative embodiment of the invention.

To facilitate understanding, identical reference numerals have been used, wherever possible, to designate identical elements that are common to the figures. Additionally, elements of one or more embodiments may be advantageously adapted for utilization in other embodiments described herein.

### DETAILED DESCRIPTION

The various embodiments of systems and methods for rendering articulated objects using three-dimensional (3D) Gaussian Splatting disclosed herein leverage 3D Gaussian Splatting to perform part-level reconstruction and estimate the kinematic model of an articulated object, given posed images of the articulated object in two different articulation states. In the various embodiments, the optimization process is self-supervised, enabling rapid and realistic synthesis of novel views and novel articulation states for articulated objects. In some embodiments, average users can employ the framework described herein to reconstruct their own articulated objects using only a handheld camera (e.g., a cellular-phone camera). The various embodiments achieve state-of-the-art performance in terms of kinematic accuracy and reconstruction fidelity without 3D mesh supervision, articulation data, or semantic labels.

As those skilled in the art are aware, 3D Gaussian Splatting (3DGS) is a technique for representing a scene in three dimensions. 3DGS models a scene using a collection of Gaussian distributions (sometimes referred to as “blobs” or “splats”). A scene can be made up of millions of such “splats” or “blobs.” These can be rendered in an efficient manner to generate an image. Each “blob” or “splat” has an associated position (in 3D space), an orientation, a scale, an opacity, and a color. This differentiable information for rendering a particular scene can be obtained through an optimization process from image observations, as described in detail below. These Gaussian distributions may be thought of as “primitives” (building blocks) for quickly and efficiently rendering a scene. They are referred to as “Gaussian” because each primitive resembles a Gaussian distribution; it has a mean and a covariance. To those properties, the scale, opacity, and color are added. The Gaussian distributions may be likened to “balls” (spheres) in 3D space that overlap to varying degrees with one another.

In one embodiment, an articulated-objects 3D reconstruction and rendering system acquires and pre-processes first and second sets of posed images of an articulated object that correspond, respectively, to first and second articulation states of the articulated object. For example, the first set of posed images might depict a cabinet whose drawer is in a closed position, and the second set of posed images might depict the drawer in an open position. Based on the first and second sets of posed images, the system generates, through a three-stage self-supervised optimization process, a 3D reconstruction model employing 3D Gaussian Splatting that synthesizes novel views and articulation states of the articulated object. For example, the 3D reconstruction model might render the cabinet just mentioned with the drawer a quarter of the way open and from a different vantage point than the images in the first and second sets of posed images.

In the first stage of the self-supervised optimization process, Separate Per-State Reconstruction, the 3D reconstruction model is optimized to reconstruct, in 3D, an articulated object in the first and second articulation states corresponding to the first and second sets of posed images, respectively. In the second stage, Cross-Static Formulation for Mobility Estimation, which is subdivided into (a) Coarse Mobility Estimation via Cross-Static Geometric Consistency and (b) Joint Mobility and Gaussian Optimization via Cross-Static Rendering, the 3D reconstruction model is optimized to identify a static part and a moveable part of the articulated object. In the third stage, Cross-Mobile Formulation for Articulation Estimation and Mobility Refinement, which is subdivided into (a) Coarse Articulation Estimation via Geometric Consistency; (b) Joint Articulation, Mobility, and Gaussian Optimization via Cross-Mobile Rendering; and (c) Mobility Correction via Cross-Mobile Geometric Consistency, the 3D reconstruction model is optimized to model movement of the moveable part of the articulated object relative to the static part (the kinematic model mentioned above). The various 3DGS parameters, including mobility parameters, that are optimized through the three-stage self-supervised optimization process are sometimes described herein as being “learned parameters.”

In this embodiment, the system outputs the 3D reconstruction model resulting from the three-stage self-supervised optimization process to a computing platform that performs one or more of visualization, simulation, interactive simulation, analysis, design, troubleshooting, and fabrication pertaining to the articulated object. For example, in one embodiment, the computing platform equipped with the 3D reconstruction model receives an input camera pose and an input articulation state for an articulated object and renders (e.g., on a display) a view of the articulated object in accordance with the input camera pose and the input articulation state using the 3D reconstruction model. As discussed above, in some instances, the input camera pose and the input articulation state can be novel (i.e., different from the first and second sets of posed images used to optimize the parameters of the 3D reconstruction model). In another embodiment, the computing platform 3D prints either a physical model or a modified physical model of an articulated object using the generated 3D reconstruction model.

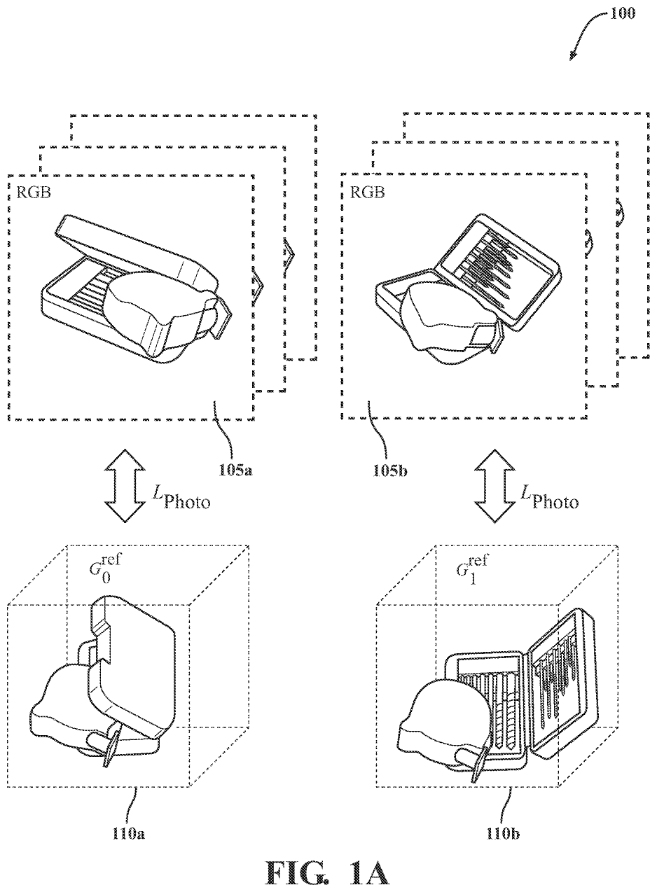

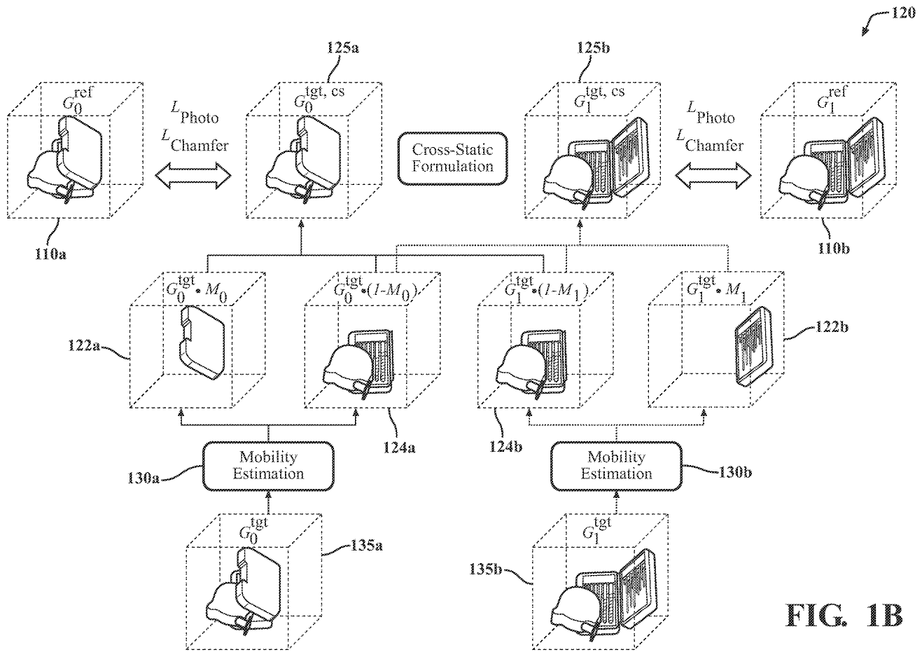

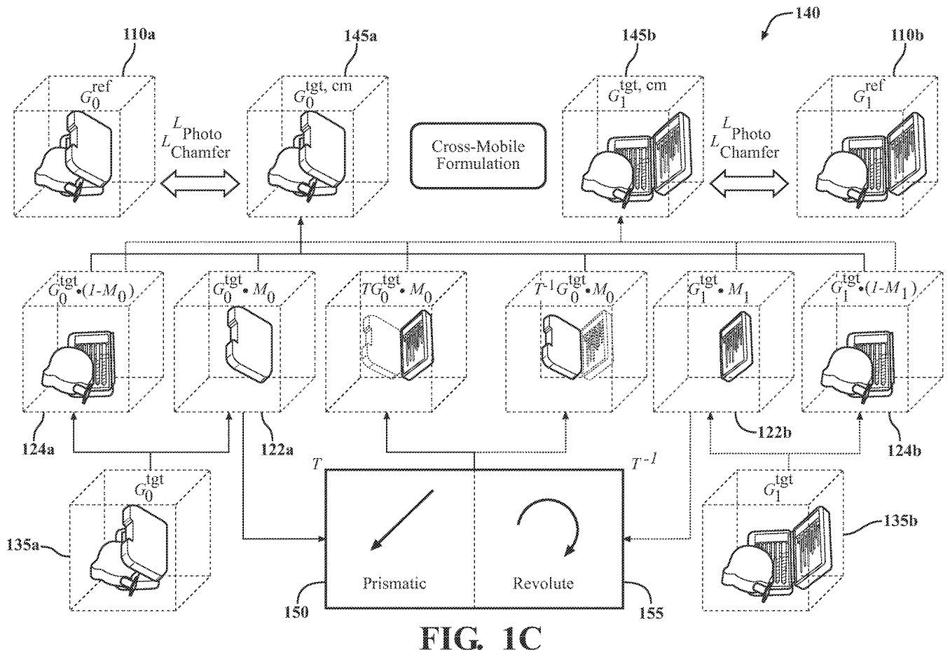

Referring to FIG. 1A, it is a diagram 100 of the first stage (Stage 1) of a three-stage self-supervised optimization process to generate a 3D reconstruction model that renders novel views and articulation states of an articulated object using 3D Gaussian Splatting, in accordance with an illustrative embodiment of the invention. Before discussing the specifics of Stage 1, an introductory overview of 3D Gaussian Splatting will first be provided to establish the notation and context for the description of the various embodiments.

Consider an arbitrary articulated object composed of at least two rigid parts: a static parent part and a child part that can move relative to its parent through either a revolute or prismatic articulation. As those skilled in the art are aware, a “prismatic articulation” refers to linear motion (sliding) along a single axis (e.g., the opening and closing of a drawer), and a “revolute articulation” relates to rotational movement around a single axis (e.g., the opening and closing of a pair of scissors or the opening and closing of a door on hinges). The toolbox in FIGS. 1A-1C is an example of an articulated object with revolute articulation, the hinged lid of the toolbox being the movable part.

In the various embodiments described herein, the objective is twofold: (1) to reconstruct an articulated object at the part level; and (2) to estimate the articulated motion of the articulated object. Assuming a known articulation type (i.e., revolute or prismatic), the input includes two sets of posed images (i.e., images with known camera intrinsics and extrinsics) 105a and 105b, each set of posed images 105 capturing the articulated object at one of the end states of its motion (e.g., one set of posed images with the toolbox lid closed or mostly closed and another set of posed images with the toolbox lid fully or mostly open). In some embodiments, the images in the input sets of posed images 105a and 105b are Red-Green-Blue (RGB) images.

More formally, let l denote the articulation-state label, where l=0 and l=1 correspond to the two end states of the observed articulation (movement) mentioned above. During the three-stage self-supervised optimization process discussed above, the articulated-objects 3D reconstruction and rendering system uses observations

$${𝒪}_{l} = {\{ ( {I}_{l}^{i} , {P}_{l}^{i} , {K}_{l}^{i} ) \}}_{i = 1}^{{N}_{l}} , l ∈ \{ 0 , 1 \} , where {I}_{l}^{i}$$

is the ith observed posed image of the articulated object in articulation state

$$l ; {P}_{l}^{i} and {K}_{l}^{i}$$

denote the associated camera extrinsics and intrinsics, respectively; and Ni represents the number of data samples (posed images 105) for state l. Note that

$${P}_{l}^{i}$$

is specified in a global world space shared by both states (State 0 and State 1), while the articulated motion involves only one moving part with respect to the world space. In embodiments, the system models a revolute articulation with its rotation axis a (∥a∥=1), pivot p, and rotation angle θ, such that a point x (in the world space) on the mobile part at State 0 (l=0) will be transformed to ¹T₀X=R_{a,θ}(x−p)+p at State 1 (l=1), where R_{a,θ} is the rotation induced by the axis-angle notation. A prismatic articulation is instead modeled by its translation axis a (∥a∥=1) and distance d.

The various embodiments described herein extend the 3DGS representation for articulated objects, decoupling the goals of part-level reconstruction and articulation estimation across three stages: (1) separate reconstructions for each articulation state (State 0 and State 1), (2) mobility estimation using the cross-static formulation, and (3) articulation estimation and mobility refinement using the cross-mobile formulation. To facilitate application of the approach described herein to real-world objects, some embodiments leverage modern structure-from-motion and image-segmentation techniques, developing a framework that enables general users to reconstruct articulated objects in their surroundings using only images captured by a handheld camera device (e.g., a cellular-phone camera), as discussed above. Joint part-level reconstruction and articulation estimation of an articulated object is susceptible to local minima, making it preferable to strategically decouple the problem into multiple stages, as described below and diagrammed in FIGS. 1A-1C.

Referring again to FIG. 1A, the two sets of posed images that correspond to State 0 and State 1 are, respectively, first set of posed images 105a and second set of posed images 105b. In this context, the designations “first” and “second” are arbitrary. In Stage 1, referred to herein as “Separate Per-State Reconstruction,” two 3DGS models are separately optimized, one for each end state of the articulation (State 0 and State 1). Specifically, in addition to the attributes from original 3DGS, each Gaussian blob is additionally initialized with a persistent binary state label l, equally drawn from {0,1}. The set of Gaussians representing state l are denoted as

$${min}_{{𝒢}_{l}^{ref}} {Δ}_{I} ( {\hat{I}}_{l}^{ref , i} , {I}_{l}^{i} ) ,$$

$${\hat{I}}_{l}^{ref , i} R ( {𝒢}_{l}^{ref} , {P}_{l}^{i} , {K}_{l}^{i} ) , l ∈ \{ 0 , 1 \} ,$$

(110a and 110b in FIG. 1A), where “ref” emphasizes that [symbol] is the reference reconstruction unaffected by the other state. Given a data sample (posed image 105) observed at state l, Stage 1 involves solving the following optimization:

$${min}_{{𝒢}_{l}^{ref}} {Δ}_{I} ( {\hat{I}}_{l}^{ref , i} , {I}_{l}^{i} ) ,$$

$${\hat{I}}_{l}^{ref , i} = R ( {𝒢}_{l}^{ref} , {P}_{l}^{i} , {K}_{l}^{i} ) , l ∈ \{ 0 , 1 \} ,$$

where R is the 3DGS rendering function, and Δ_{I} represents the photometric loss. For simplicity, the view index i and camera parameters

$${P}_{l}^{i} and {K}_{l}^{i}$$

are omitted from the notation in the description of Stages 2 and 3 below.

FIG. 1B is a diagram 120 of the second stage (Stage 2) of a three-stage self-supervised optimization process to generate a 3D reconstruction model that renders novel views and articulation states of an articulated object using 3D Gaussian Splatting, in accordance with an illustrative embodiment of the invention. The focus of Stage 2, referred to herein as “Cross-Static Formulation for Mobility Estimation,” is mobility estimation (130) for each Gaussian. To keep [symbol] dedicated to the single-state reconstruction,

$${𝒢}_{l}^{ref}$$

(110) is first duplicated as

$${\text{?}}_{l}^{tgt}$$

(135) for both states (State 0 and State 1), which is intended as the target representation 135 that will fulfill the goals of part-level reconstruction and articulation estimation. Note that [symbol] shares neither data storage nor gradient flow with [symbol] after its creation.

For each Gaussian in [symbol] , its set of attributes is further extended with the addition of a mobility value m∈[0,1], initialized, in some embodiments, with 0.5 (in other embodiments, the mobility attributes of [symbol] are initialized with random values). By design, m enables the breakdown of a Gaussian into its static (124) and mobile (122) components, where each component inherits all the original Gaussian attributes except for the opacity σ. The static component (124) has its opacity modified to σ·(1−m) and the mobile component (122) to σ·m. For simplicity, letting [symbol] be the set of mobilities for [symbol] , the element-wise product [symbol] ·(1− [symbol] ) can be used to denote the static component (124) of [symbol] , and [symbol] · [symbol] can be used to denote the mobile component (122).

To estimate the mobilities [symbol] , the system employs the observation that the static components from both articulation states (State 0 and State 1) should constitute the static part (124) of the articulated object. Formally, the system employs the cross-static (cs) formulation, where the static part (124) of the articulated object is jointly represented as

$${\text{?}}^{S} = {\text{?}}_{l}^{tgt} \cdot ( 1 - {\text{?}}_{l} ) ⊕ {\text{?}}_{1 - l}^{tgt} \cdot ( 1 - {\text{?}}_{1 - l} ) ,$$

where ⊕ denotes concatenation. For state l, the target representation (125) thus becomes

$${\text{?}}_{l}^{tgt , cs} = {\text{?}}^{S} ⊕ {\text{?}}_{l}^{tgt} \cdot {\text{?}}_{l} .$$

With this formulation, Stage 2 is further subdivided into two sub-stages, as described below.

Stage 2(a) is referred to herein as “Coarse Mobility Estimation via Cross-Static Geometric Consistency.” To measure the geometric distance between two Gaussian sets, a weighted version of the Chamfer distance is used that considers both the mean and opacity of each Gaussian, essentially treating a Gaussian with opacity σ as σ points overlapped at the same location. The mobilities (mobility attributes) are then optimized by encouraging the geometric consistency formulated as follows:

$${min}_{\text{?}} {CD}_{0}^{cs} + {CD}_{1}^{cs} + {λ}_{m}^{geom} ‖ \text{?} ‖ ,$$

$${CD}_{l}^{cs} = Chamfer ( {\text{?}}_{l}^{tgt , cs} , {\text{?}}_{l}^{ref} ) ,$$

where Chamfer(·) denotes the weighted Chamfer distance, and λ [symbol] ∥M∥ is the regularization term that encourages smaller mobilities. Note how [symbol] affects the weighted Chamfer distance by modifying the opacities and that [symbol] =1 is a trivial solution without the regularization. Without photometric supervision, the mobilities obtained from the approach just described tend to be noisy. However, being relatively fast (taking only tens of seconds), they still serve as a good initialization for the next sub-stage (Stage 2(b)) described below.

Stage 2(b) is referred to herein as “Joint Mobility and Gaussian Optimization via Cross-Static Rendering.” In some embodiments, to more accurately estimate the mobilities while jointly refining the full Gaussian attributes, cross-static rendering is performed as follows:

$${min}_{{\text{?}}^{tgt} , {\text{?}}_{1 - l}} {Δ}_{I} ( {\hat{I}}_{l}^{cs} , {I}_{l} ) + {λ}_{m}^{photo} ‖ {\text{?}}_{1 - l} ‖ ,$$

$${\hat{I}}_{l}^{cs} = R ( {\text{?}}_{l}^{tgt , cs} ) ,$$

where

$${λ}_{m}^{photo} ‖ {\text{?}}_{1 - l} ‖$$

is a mobility regularization term similar to that discussed above in connection with Stage 2(a).

FIG. 1C is a diagram 140 of the third stage (Stage 3) of a three-stage self-supervised optimization process to generate a 3D reconstruction model that renders novel views and articulation states of an articulated object using 3D Gaussian Splatting, in accordance with an illustrative embodiment of the invention. The focus of Stage 3, referred to herein as “Cross-Mobile Formulation for Articulation Estimation and Mobility Refinement,” is to estimate the articulation parameters shared by the mobile components of all Gaussians. To this end, the observation is applied that the mobile components from the two end states (State 0 and State 1) are related through the articulated motion. Formally, the cross-mobile (cm) formulation is introduced, where the mobile part of the articulated object at state [symbol] is jointly represented as

$${\text{?}}_{l}^{m} = {\text{?}}_{l}^{tgt} \cdot {\text{?}}_{l} ⊕ {}_{}^{l} {T}_{1 - l}^{} ( {\text{?}}_{1 - l}^{tgt} \cdot {\text{?}}_{1 - l} ) ,$$

where ^{l}T₁₋ₗ( [symbol] ) denotes the transformation of Gaussians G according to the articulated motion from state 1− [symbol] to [symbol] . For state l, the target representation (145) thus becomes

$${\text{?}}_{l}^{tgt , cm} = {\text{?}}^{S} ⊕ {\text{?}}_{l}^{m} ,$$

where [symbol] ^{S} is defined above in the introductory discussion of Stage 2. As shown in FIG. 1C, the estimated articulation parameters account for prismatic articulation 150 or revolute articulation 155, whichever applies (in this example, it is revolute articulation). With the above formulation, Stage 3 is further subdivided into three sub-stages, as described below.

Stage 3(a) is referred to herein as “Coarse Articulation Estimation via Geometric Consistency.” Similar to its application in connection with Stage 2(a) above, weighted Chamfer distance is used to compute the cross-mobile geometric consistency (a geometric supervision signal), which can be optimized over both mobilities and articulation parameters as follows:

$${min}_{\text{?} , T} {CD}_{0}^{cm} + {CD}_{1}^{cm} ,$$

$${CD}_{l}^{cm} = Chamfer ( {\text{?}}_{l}^{tgt , cm} , {\text{?}}_{l}^{ref} ) .$$

The above formulation is still susceptible to local minima if the mobile part is too geometrically insignificant. To address that issue, mobile-only geometric consistency (another geometric supervision signal), which concerns only the mobile components of both end articulation states, is applied as follows:

$${CD}^{m} = Chamfer ( {\text{?}}_{l}^{tgt} \cdot {\text{?}}_{l} , {}_{}^{l} {T}_{1 - l}^{} ( {\text{?}}_{1 - l}^{tgt} \cdot {\text{?}}_{1 - l} ) ) .$$

While successfully addressing some scenarios, mobile-only geometric consistency still falls short in other circumstances, especially when the mobile components in the two states exhibit large discrepancies. To take advantage of both formulations and to facilitate robustness in the inherently non-convex optimization of articulation parameters, some embodiments of an articulated-objects 3D reconstruction and rendering system include the following practical solution. First, with K^{m} randomized tries, articulation estimation via

$${T}^{m} = arg {min}_{T} {CD}^{m}$$

is applied. Second, with K^{cm} randomized tries, plus another initialized with T^{m}, articulation estimation via

$${T}^{cm} = arg {min}_{T} {CD}_{0}^{cm} + {CD}_{1}^{cm}$$

is applied. Third, a final run is initialized with T^{cm}, and joint articulation estimation and mobility refinement is applied as discussed above

$$( i . e . , {min}_{\text{?} , T} {CD}_{0}^{cm} + {CD}_{1}^{cm} ) .$$

Stage 3(b) is referred to herein as “Joint Articulation, Mobility, and Gaussian Optimization via Cross-Mobile Rendering.” As in Stage 2(b) above, the system performs a full joint optimization over articulation parameters, mobilities, and Gaussians using photometric supervision via cross-mobile rendering as follows:

$${min}_{{\text{?}}^{tgt} , {\text{?}}_{1 - l} , {}_{}^{l} {T}_{1 - l}^{}} {Δ}_{I} ( {\hat{I}}_{l}^{cm} , {I}_{l} ) ,$$

$${\hat{I}}_{l}^{cm} = R ( {\text{?}}_{l}^{tgt , cm} ) , l ∈ \{ 0 , 1 \} .$$

Stage 3(c) is referred to herein as “Mobility Correction via Cross-Mobile Geometric Consistency.” Stage 3(b) above relies solely on photometric supervision, which is limited to the training (optimization) views. On rare occasions, a Gaussian may be mistakenly estimated as mobile if the articulated motion moves it out of sight from most views, effectively losing the supervision. On the other hand, geometric consistency is not affected by sight limitations, which some embodiments leverage for mobility correction as follows:

$${min}_{\text{?}} {CD}_{0}^{cm} + {CD}_{1}^{cm} .$$

The various embodiments of an articulated-objects 3D reconstruction and rendering system have many practical applications. For example, one application is permitting a human user to analyze an articulated object via the optimized 3D representation/reconstruction that the model provides, including the ability to analyze novel views and articulation states. Depending on the embodiment, this can involve simulations of various kinds, including interactive simulations in which the user can manipulate the view and articulation state of the articulated object in real time. The 3D representation produced by the embodiments described herein can also be used to generate a mesh representation or a point cloud for a downstream application. The techniques described herein can also be applied to computer gaming.

In more general terms, a major application for the articulated-objects 3D reconstruction and rendering system is “extracting digital assets from the real world” or what is sometimes called “real to sim” by those skilled in the art. For example, in tabletop robotics, the need sometimes arises to quickly and efficiently generate digital assets representing articulated objects without relying on computer-graphics experts to develop such a model through manual analysis and programming. As discussed above, some embodiments of an articulated-objects 3D reconstruction and rendering system described herein permit a user to capture some images of an articulated object using, e.g., a smartphone camera and to generate a 3D representation (a digital asset) with which the user can interact to study and analyze the articulated object for various purposes, including the design and optimization of robots or other products. Such applications include analysis, design, troubleshooting, and fabrication pertaining to the articulated object. Regarding fabrication, in some embodiments, a computing system to which the resulting 3D reconstruction model has been output 3D prints a physical model of the articulated object. In some embodiments, the physical model 3D printed can be a modified version of the articulated object compared with the original posed images 105 used to optimize the 3D reconstruction model. For example, a user interacting with a simulation of the articulated object can make structural changes to the articulated object in the digital domain that are then reflected in the physical model that is 3D printed.

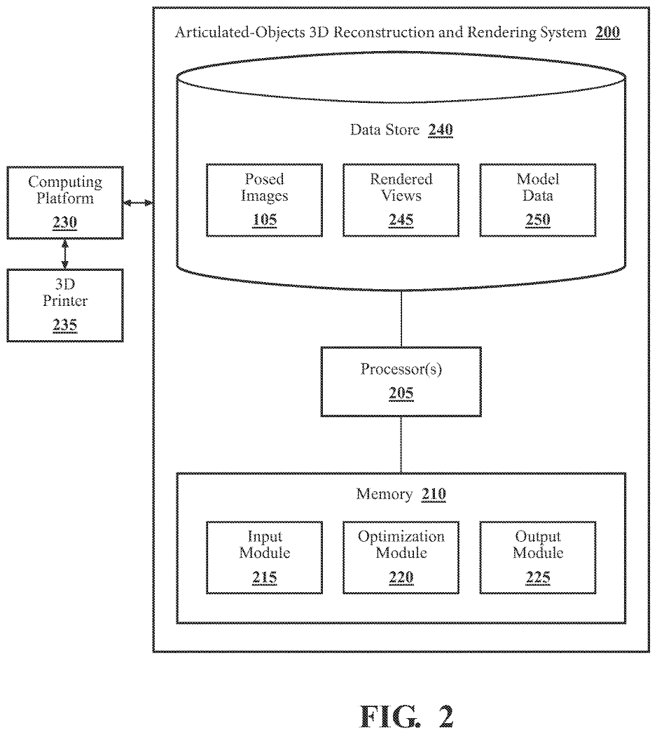

FIG. 2 is a block diagram of an articulated-objects 3D reconstruction and rendering system 200 (hereinafter often referred to simply as the “system 200”), in accordance with an illustrative embodiment of the invention. In FIG. 2, the articulated-objects 3D reconstruction and rendering system 200 is shown as including one or more processors 205. Depending on the embodiment, the system 200 can be implemented using a server computer, a desktop client computer, or a mobile computing device.

The system 200 also includes a memory 210 communicably coupled to the one or more processors 205 and storing machine-readable instructions. In the embodiment of FIG. 2, the memory 210 stores an input module 215, an optimization module 220, and an output module 225. The memory 210 is a random-access memory (RAM), read-only memory (ROM), a hard-disk drive, a flash memory, or other suitable memory for storing the modules 215, 220, and 225. The modules 215, 220, and 225 are, for example, machine-readable instructions that when executed by the one or more processors 205, cause the one or more processors 205 to perform the various functions disclosed herein.

In connection with its tasks, system 200 can store various kinds of data in a data store 240. For example, in the embodiment shown in FIG. 2, system 200 stores, in data store 240, posed images 105, model data 250, and rendered views 245. Model data 250 includes the various parameters of the Gaussian distributions used in 3DGS, including the mobility parameters/attributes discussed above in connection with FIGS. 1B and 1C. Rendered views 245 are views, including novel views, produced by the optimized 3D reconstruction model. As discussed above, the novel views can depict an articulated object in articulation states other than the end states (State 0 and State 1) used to train the model (i.e., novel articulation states).

As shown in FIG. 2, in some embodiments, the articulated-objects 3D reconstruction and rendering system 200 communicates with a computing platform 230, which is, in turn, connected with a 3D printer 235. In various embodiments, the computing platform 230 can be any of a variety of different computing or computerized systems, including, without limitation, a computer-aided design (CAD) system, a server, a mobile computing device, or a robot. In some embodiments, the computing platform 230 and the computing system hosting the articulated-objects 3D reconstruction and rendering system 200 are one and the same.

Input module 215 generally includes instructions that, when executed by the one or more processors 205, cause the one or more processors 205 to pre-process first and second sets of posed images (105a and 105b) of an articulated object that correspond, respectively, to first and second articulation states of the articulated object. As discussed above, in some embodiments, the two sets of posed images (105a and 105b) correspond to the end states of the motion of the articulated object's mobile part (122). In some embodiments, the pre-processing performed by input module 215 includes applying modern structure-from-motion and image-segmentation techniques to the posed images 105 before they are used to optimize the parameters of the 3DGS-based model. In some embodiments, the images in the input sets of posed images 105 are RGB images, as discussed above.

Optimization module 220 generally includes instructions that, when executed by the one or more processors 205, cause the one or more processors 205 to generate, through first (100), second (120), and third (140) stages of a self-supervised optimization process based on the first and second sets of posed images (105a and 105b), a 3D reconstruction model employing 3DGS that synthesizes novel views and articulation states of the articulated object. As a brief summary of the detailed explanation of the three stages of the optimization process discussed above in connection with FIGS. 1A-1C, the 3D reconstruction model is optimized to reconstruct the articulated object in the first and second articulation states, respectively, in the first stage (100), to identify a static part (124) and a movable part (122) of the articulated object in the second stage (120), and to model movement of the moveable part (122) relative to the static part (124) in the third stage (140). As explained above, joint part-level reconstruction and articulation estimation of an articulated object is susceptible to local minima, making it preferable to strategically decouple the problem into multiple stages, as described above in connection with FIGS. 1A-1C. The three-stage self-supervised optimization process described above includes, among other important features, optimizable mobility values (the mobility parameters/attributes of the Gaussian distributions discussed above) and geometric consistency for mobile parts (122).

Output module 225 generally includes instructions that, when executed by the one or more processors 205, cause the one or more processors 205 to output the optimized 3D reconstruction model to a computing platform 230 that performs one or more of visualization, simulation, interactive simulation, analysis, design, troubleshooting, and fabrication pertaining to the articulated object. As discussed above, in some embodiments, the computing system 230 to which the resulting 3D reconstruction model has been output 3D prints a physical model of the articulated object. In some embodiments, the physical model 3D printed can be a modified version of the articulated object compared with the original posed images 105 used to optimize the 3D reconstruction model. For example, a user interacting with a simulation of the articulated object can make structural changes to the articulated object in the digital domain that are then reflected in the physical model that is 3D printed.

As discussed above, in one embodiment, the computing platform 230 equipped with the 3D reconstruction model receives an input camera pose and an input articulation state for an articulated object and renders (e.g., on a display) a view of the articulated object in accordance with the input camera pose and the input articulation state using the optimized 3D reconstruction model. As discussed above, in some instances, the input camera pose and the input articulation state are novel (i.e., different from the first and second sets of posed images 105a and 105b used to optimize the parameters of the 3D reconstruction model).

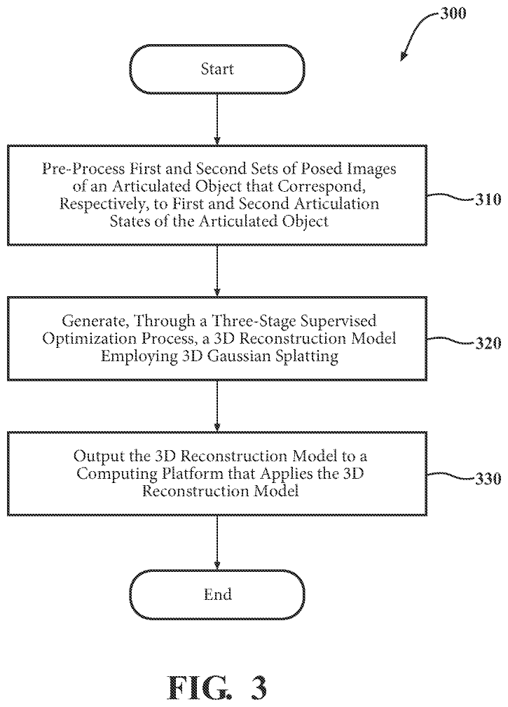

FIG. 3 is a flowchart of a method 300 of rendering articulated objects using 3D Gaussian Splatting, in accordance with an illustrative embodiment of the invention. Method 300 will be discussed from the perspective of articulated-objects 3D reconstruction and rendering system 200 in FIG. 2 with reference to FIGS. 1A-1C. While method 300 is discussed in combination with the system 200, it should be appreciated that method 300 is not limited to being implemented within the system 200, but the system 200 is instead one example of a system that may implement method 300.

At block 310, input module 215 pre-processes first and second sets of posed images (105a and 105b) of an articulated object that correspond, respectively, to first and second articulation states of the articulated object. As discussed above, in some embodiments, the two sets of posed images (105a and 105b) correspond to the end states of the motion of the articulated object's mobile part (122). In some embodiments, the pre-processing that input module 215 performs includes applying modern structure-from-motion and image-segmentation techniques to the posed images 105 before they are used to optimize the parameters of the 3DGS-based model. In some embodiments, the images in the input sets of posed images 105 are RGB images, as discussed above.

At block 320, optimization module 220 generates, through first (100), second (120), and third (140) stages of a self-supervised optimization process based on the first and second sets of posed images (105a and 105b), a 3D reconstruction model employing 3D Gaussian Splatting that synthesizes novel views and articulation states of the articulated object. As a brief summary of the detailed explanation of the three stages of the optimization process discussed above in connection with FIGS. 1A-1C, the 3D reconstruction model is optimized to render the articulated object in the first and second articulation states, respectively, in the first stage (100), to identify a static part (124) and a movable part (122) of the articulated object in the second stage (120), and to model movement of the moveable part (122) relative to the static part (124) in the third stage (140). As explained above, joint part-level reconstruction and articulation estimation of an articulated object is susceptible to local minima, making it preferable to strategically decouple the problem into multiple stages, as described above in connection with FIGS. 1A-1C. The three-stage self-supervised optimization process described above includes, among other important features, optimizable mobility values (the mobility parameters/attributes of the Gaussian distributions discussed above) and geometric consistency for mobile parts (122).

At block 330, output module 225 outputs the 3D reconstruction model to a computing platform 230 that performs one or more of visualization, simulation, interactive simulation, analysis, design, troubleshooting, and fabrication pertaining to the articulated object. As discussed above, in some embodiments, the computing system 230 to which the resulting 3D reconstruction model has been output 3D prints a physical model of the articulated object. In some embodiments, the physical model 3D printed can be a modified version of the articulated object compared with the original posed images 105 used to optimize the 3D reconstruction model. For example, a user interacting with a simulation of the articulated object can make structural changes to the articulated object in the digital domain that are then reflected in the physical model that is 3D printed.

In some embodiments, method 300 can include other actions beyond what is shown in FIG. 3. For example, as discussed above, in one embodiment, the computing platform 230 equipped with the 3D reconstruction model receives an input camera pose and an input articulation state for an articulated object and renders (e.g., on a display) a view of the articulated object in accordance with the input camera pose and the input articulation state using the optimized 3D reconstruction model. As also discussed above, in some instances, the input camera pose and the input articulation state are novel (i.e., different from the first and second sets of posed images 105a and 105b used to optimize the parameters of the 3D reconstruction model).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1A-3, but the embodiments are not limited to the illustrated structure or application.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Generally, “module,” as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

Aspects herein can be embodied in other forms without departing from the spirit or essential attributes thereof. Accordingly, reference should be made to the following claims rather than to the foregoing specification, as indicating the scope hereof.

What is claimed is:

1. A system, comprising:
a processor; and
a memory storing machine-readable instructions that, when executed by the processor, cause the processor to:
pre-process first and second sets of posed images of an articulated object that correspond, respectively, to first and second articulation states of the articulated object;
generate, through first, second, and third stages of a self-supervised optimization process based on the first and second sets of posed images, a three-dimensional (3D) reconstruction model employing 3D Gaussian Splatting that synthesizes novel views and articulation states of the articulated object, wherein the 3D reconstruction model reconstructs the articulated object in the first and second articulation states, respectively, in the first stage, identifies a static part and a movable part of the articulated object in the second stage, and models movement of the moveable part relative to the static part in the third stage; and
output the 3D reconstruction model to a computing platform that performs one or more of visualization, simulation, interactive simulation, analysis, design, troubleshooting, and fabrication pertaining to the articulated object.

2. The system of claim 1, wherein the computing platform 3D prints one of a physical model and a modified physical model of the articulated object using the 3D reconstruction model.

3. The system of claim 1, wherein the second stage is subdivided into (a) coarse mobility estimation via cross-static geometric consistency and (b) joint mobility and Gaussian optimization via cross-static rendering.

4. The system of claim 3, wherein the joint mobility and Gaussian optimization via cross-static rendering includes refining learned mobility parameters of Gaussian distributions in the 3D Gaussian Splatting through joint optimization of the learned mobility parameters and other learned parameters of the Gaussian distributions.

5. The system of claim 1, wherein the third stage includes use of photometric and geometric supervision signals and is subdivided into (a) coarse articulation estimation via geometric consistency, (b) joint articulation, mobility, and Gaussian optimization via cross-mobile rendering, and (c) mobility correction via cross-mobile geometric consistency.

6. The system of claim 1, wherein the computing platform receives an input camera pose and an input articulation state for the articulated object and renders a view of the articulated object in accordance with the input camera pose and the input articulation state using the 3D reconstruction model.

7. The system of claim 1, wherein the first and second sets of posed images are captured using a cellular-phone camera.

8. A non-transitory computer-readable medium storing instructions that, when executed by a processor, cause the processor to:
pre-process first and second sets of posed images of an articulated object that correspond, respectively, to first and second articulation states of the articulated object;
generate, through first, second, and third stages of a self-supervised optimization process based on the first and second sets of posed images, a three-dimensional (3D) reconstruction model employing 3D Gaussian Splatting that synthesizes novel views and articulation states of the articulated object, wherein the 3D reconstruction model reconstructs the articulated object in the first and second articulation states, respectively, in the first stage, identifies a static part and a movable part of the articulated object in the second stage, and models movement of the moveable part relative to the static part in the third stage; and
output the 3D reconstruction model to a computing platform that performs one or more of visualization, simulation, interactive simulation, analysis, design, troubleshooting, and fabrication pertaining to the articulated object.

9. The non-transitory computer-readable medium of claim 8, wherein the computing platform 3D prints one of a physical model and a modified physical model of the articulated object using the 3D reconstruction model.

10. The non-transitory computer-readable medium of claim 8, wherein the second stage is subdivided into (a) coarse mobility estimation via cross-static geometric consistency and (b) joint mobility and Gaussian optimization via cross-static rendering.

11. The non-transitory computer-readable medium of claim 10, wherein the joint mobility and Gaussian optimization via cross-static rendering includes refining learned mobility parameters of Gaussian distributions in the 3D Gaussian Splatting through joint optimization of the learned mobility parameters and other learned parameters of the Gaussian distributions.

12. The non-transitory computer-readable medium of claim 8, wherein the third stage includes use of photometric and geometric supervision signals and is subdivided into (a) coarse articulation estimation via geometric consistency, (b) joint articulation, mobility, and Gaussian optimization via cross-mobile rendering, and (c) mobility correction via cross-mobile geometric consistency.

13. The non-transitory computer-readable medium of claim 8, wherein the computing platform receives an input camera pose and an input articulation state for the articulated object and renders a view of the articulated object in accordance with the input camera pose and the input articulation state using the 3D reconstruction model.

14. A method, comprising:
pre-processing first and second sets of posed images of an articulated object that correspond, respectively, to first and second articulation states of the articulated object;
generating, through first, second, and third stages of a self-supervised optimization process based on the first and second sets of posed images, a three-dimensional (3D) reconstruction model employing 3D Gaussian Splatting that synthesizes novel views and articulation states of the articulated object, wherein the 3D reconstruction model reconstructs the articulated object in the first and second articulation states, respectively, in the first stage, identifies a static part and a movable part of the articulated object in the second stage, and models movement of the moveable part relative to the static part in the third stage; and
outputting the 3D reconstruction model to a computing platform that performs one or more of visualization, simulation, interactive simulation, analysis, design, troubleshooting, and fabrication pertaining to the articulated object.

15. The method of claim 14, further comprising 3D printing, via the computing platform based on the 3D reconstruction model, one of a physical model and a modified physical model of the articulated object.

16. The method of claim 14, wherein the second stage is subdivided into (a) coarse mobility estimation via cross-static geometric consistency and (b) joint mobility and Gaussian optimization via cross-static rendering.

17. The method of claim 16, wherein the joint mobility and Gaussian optimization via cross-static rendering includes refining learned mobility parameters of Gaussian distributions in the 3D Gaussian Splatting through joint optimization of the learned mobility parameters and other learned parameters of the Gaussian distributions.

18. The method of claim 14, wherein the third stage includes use of photometric and geometric supervision signals and is subdivided into (a) coarse articulation estimation via geometric consistency, (b) joint articulation, mobility, and Gaussian optimization via cross-mobile rendering, and (c) mobility correction via cross-mobile geometric consistency.

19. The method of claim 14, further comprising:
receiving, at the computing platform, an input camera pose and an input articulation state for the articulated object; and
rendering, via the computing platform, a view of the articulated object in accordance with the input camera pose and the input articulation state using the 3D reconstruction model.

20. The method of claim 14, wherein the first and second sets of posed images are captured using a cellular-phone camera.
